(19) United States
(12) Patent Application Publication
(10) Pub. No.: US 2024/0146142 A1
(43) Pub. Date: May 2, 2024

(54) METHOD FOR MANUFACTURING A BUSBAR, A BUSBAR FOR A MOTOR, AND A MOTOR

(71) Applicant: MAHLE International GmbH, Stuttgart (DE)

(72) Inventors: Akihiko Eguchi, Shizuoka (JP); Shota Nogiwa, Shizuoka (JP); Yuki Suzuki, Shizuoka (JP); Tamotsu Tanaka, Shizuoka (JP)

(21) Appl. No.: 18/384,375

(22) Filed: Oct. 26, 2023

(30) Foreign Application Priority Data
Oct. 27, 2022 (JP) 2022-172350

(51) Int. Cl. H02K 3/50; H02K 15/00

(52) U.S. Cl. CPC H02K 3/50; H02K 15/0062; H02K 2203/09

(57) ABSTRACT

[Problem to be Solved]

High positional accuracy of connection terminals should be achieved in a bus bar unit for a motor.

[Solution]

A method for manufacturing a busbar unit (10) according to the present invention includes a step of molding a power connection terminal member (14) integrally with a resin plate (12) by insert molding, and a step of attaching the busbar to the power connection terminal member (14) so as to connect electrically each other.

The power connection terminal member (14) has a power connection terminal (14a) for connecting to the motor control board, and an attachment portion (14b) for attaching to a bus bar electrically connected to the coils of the stator.

The power connection terminal (14a) and the attachment portion (14b) protrude from the resin plate (12) individually. The attachment portion (14b) of the power connection terminal member (14) is welded to the attachment portion of the busbar.

### CROSS-REFERENCE TO RELATED APPLICATION

This application claims priority to Japan Application No. JP 2022-172350 filed on Oct. 27, 2022, the contents of which are hereby incorporated by reference in its entirety.

### TECHNICAL FIELD

The present invention relates to a motor, bus bar unit for a motor, and a method for manufacturing a bus bar unit for a motor, and specifically relates to a motor having a connection terminal member for connecting to an external device and a bus bar electrically connected to the coils of a stator, a bus bar unit for a motor, and a method for manufacturing a bus bar unit for a motor.

### BACKGROUND

Motors having a bus bar electrically connected to the coils of a stator, and connection terminals for connecting to an external device are known (refer to e.g., Patent Literature 1 and 2). These connection terminals extend lengthwise so as to reach the terminals of the external device side, as is understood from the drawings in Patent Literature 1 and 2.

### PATENT LITERATURE

[Patent Literature 1] JP 2019-170013 A
[Patent Literature 2] JP 2020-065358 A

### SUMMARY

As mentioned above, because the connection terminals usually extend lengthwise, if the connection terminals are even a little bit inclined, the positional accuracy of the tip portion worsens, making it difficult to join with the terminals of the external device side. Therefore, insert-molding a bus bar whose connection terminals were integrated with a resin plate has also been considered, as in the aforementioned Patent Literature 1 and 2. However, the bus bar is a comparatively large member, and there are cases where it is difficult to perform insert-molding whilst satisfying other design conditions. Meanwhile, it has also been considered to insert-mold only the connection terminals, and then join the bus bar to the connection terminals by welding etc. However, in such a case, there may be a reduction in the positional accuracy of the tip portions of the connection terminals when joining the bus bar to the connection terminals by welding etc.

Thus, the present invention has taken the aforementioned problem into consideration, with the objective of achieving a high positional accuracy of a connection terminal in a bus bar unit for a motor.

In order to solve the aforementioned problem, the method for manufacturing a bus bar unit for a motor according to the present invention includes the steps of: molding a connection terminal member integrally with a resin plate by insert molding, the connection terminal member having a connection terminal for connecting to an external device and an attachment portion for attaching to a bus bar electrically connected to coils of a stator, where the connection terminal and the attachment portion each protrude from the resin plate individually; attaching the bus bar to the resin plate; and attaching the bus bar to the attachment portion of the connection terminal member so as to electrically connect each other.

According to this mode, the connection terminal can be fixed with good accuracy by insert molding. Moreover, because the attachment portion for attaching to the bus bar protrudes with the connection terminal individually, reduction of positional accuracy of the connection terminal due to attaching the bus bar to the attachment portion can be suppressed.

The bus bar may be welded to the attachment portion of the connection terminal member in the step of attaching the bus bar to the attachment portion of the connection terminal member. According to this mode, the bus bar can be securely electrically connected to the connection terminal member. Conversely, because the welded attachment portion protrudes with the connection terminal individually, reduction of positional accuracy of the tip portion of the connection terminal can be suppressed even if welding the bus bar with the connection terminal member. Here, “the connection terminal and the attachment portion each protrude from the resin plate individually” is not limited to the mode where the connection terminal and the attachment portion are completely separated at the surface of the resin plate; a part of the portion connecting the connection terminal and attachment portion may also be exposed at the resin plate surface, as long as the impact on the connection terminal in the attaching step (such as welding and press-fitting) is suppressed.

The bus bar may be press-fitted to the resin plate in the step of attaching the bus bar to the resin plate. According to this mode, insert molding of the bus bar with the resin plate can be avoided. Therefore, the connection terminal member can be more simply and appropriately insert-molded with the resin plate.

In order to further solve the aforementioned problem, the bus bar unit for a motor according to the present invention includes: a resin plate; a connection terminal member molded integrally with the resin plate, for connecting to an external device; and a bus bar attached to the resin plate, for electrically connecting to coils of a stator. The connection terminal member has a connection terminal for connecting to an external device, and an attachment portion for attaching to the bus bar, where the connection terminal and the attachment portion each protrude from the resin plate individually. The bus bar is for attaching to the attachment portion of the connection terminal member so as to electrically connect each other.

According to this mode, because the attachment portion for attaching to the bus bar protrudes with a connection terminal individually, the bus bar unit can be provided where the reduction of positional accuracy of the connection terminal was suppressed when having attached the bus bar to the attachment portion.

### BRIEF DESCRIPTION TO THE DRAWINGS

FIG. 1 is a perspective view of a bus bar unit according to the present embodiment.

FIG. 2 is a perspective view of a power connection terminal member.

FIG. 3 is a perspective view of a first bus bar according to the present embodiment.

FIG. 4 is a perspective view of a second bus bar according to the present embodiment.

FIG. 5 is a perspective view of a third bus bar according to the present embodiment.

FIG. 6 is a perspective view of a semi-finished product produced by a process for manufacturing a bus bar unit.

### DETAILED DESCRIPTION

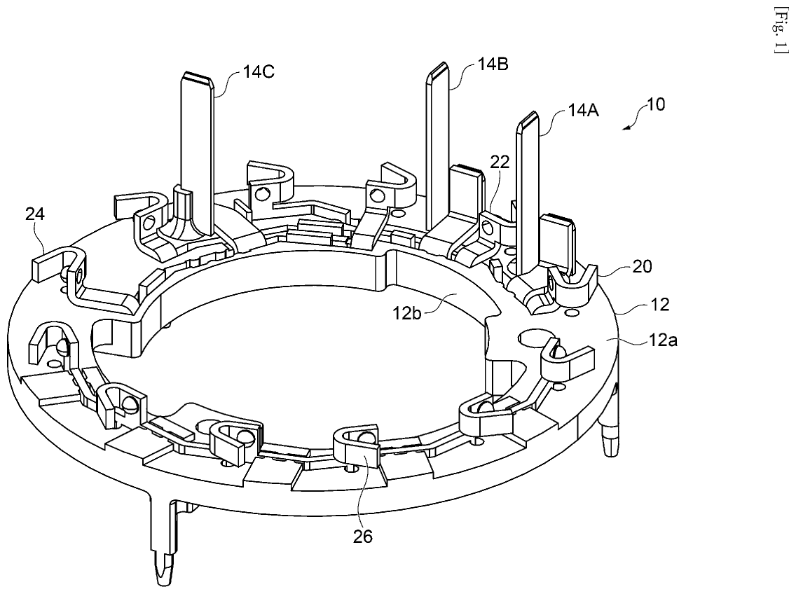

FIG. 1 is a perspective view of a bus bar unit 10 according to the present embodiment. The bus bar unit 10 has a resin plate 12, first power connection terminal member 14A, second power connection terminal member 14B, power connection terminal member 14C (hereinunder, suitably collectively referred to as “power connection terminal member 14”), first bus bar 20, second bus bar 22, third bus bar 24 and fourth bus bar 26. The bus bar unit 10 is a unit which constitutes a part of a motor. A motor is configured by the bus bar unit 10, a motor housing (not shown), a rotor (not shown), a stator (not shown) and a motor circuit board (not shown). The motor circuit board is an electronic control unit (ECU) which controls a motor.

The first power connection terminal member 14A, second power connection terminal member 14B and power connection terminal member 14C are connected to the motor circuit board (external device). The motor circuit board functions as a motor control unit which controls the operation of a motor by controlling the power supplied to a stator. The first bus bar 20, second bus bar 22, third bus bar 24 and fourth bus bar 26 are electrically connected to the coils of a stator. In the present embodiment, the bus bar unit 10 has three power connection terminal members 14 and four bus bars; however of course, the number of power connection terminal members 14 and bus bars is not limited to these.

The resin plate 12 is formed in an annular shape having a thickness, and has an opening 12b in the center. The power connection terminal member 14, first bus bar 20, second bus bar 22, third bus bar 24 and fourth bus bar 26 are fixed to resin plate 12 so that a part of the power connection terminal member 14, first bus bar 20, second bus bar 22, third bus bar 24 and fourth bus bar 26 protrudes from surface 12a of resin plate 12.

The first power connection terminal member 14A, second power connection terminal member 14B and power connection terminal member 14C are common members. Thereby, costs can be suppressed compared to the case of using respectively different members. The first power connection terminal member 14A, second power connection terminal member 14B and power connection terminal member 14C may be formed in respectively different shapes.

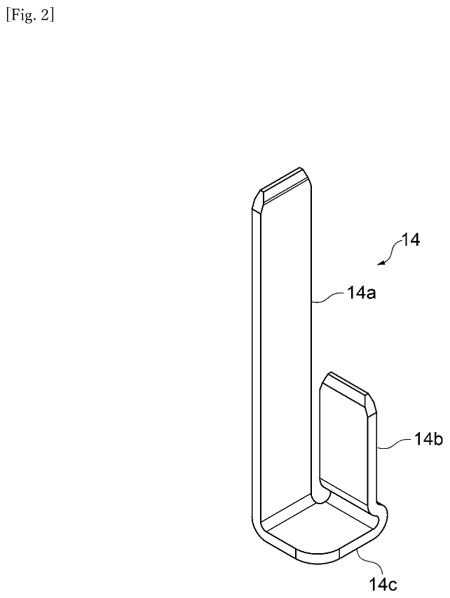

FIG. 2 is a perspective view of a power connection terminal member 14. The power connection terminal member 14 has a power connection terminal 14a, attachment portion 14b and connection portion 14c. The power connection terminal member 14 is formed by punching and then bending sheet metal. The power connection terminal 14a is formed in a long and narrow rectangular plate shape whose length is about five times the width.

This power connection terminal 14a is for connecting to the motor circuit board. The attachment portion 14b is formed in a long and narrow plate shape whose length is about twice the width. This attachment portion 14b is attached to the attachment portion of the bus bar. The corner portions of the tips of the power connection terminal 14a and the attachment portion 14b are chamfered; furthermore, the widths are tapered. The connection portion 14c is formed in a rectangular plate shape. The connection portion 14c is a part for relaying so as to electrically connect power connection terminal 14a and attachment portion 14b to each other.

One side edge of power connection terminal 14a is adjacent to one side edge of attachment portion 14b, and both are disposed with the adjacent sections thereof configured as the center, so that the angle formed from the power connection terminal 14a of the attachment portion 14b is 90 degrees. The bottom portion of power connection terminal 14a and the bottom portion of attachment portion 14b are each integrally joined to adjacent two sides of the rectangular connection portion 14c. Of course, the power connection terminal member 14 is not limited to these shapes.

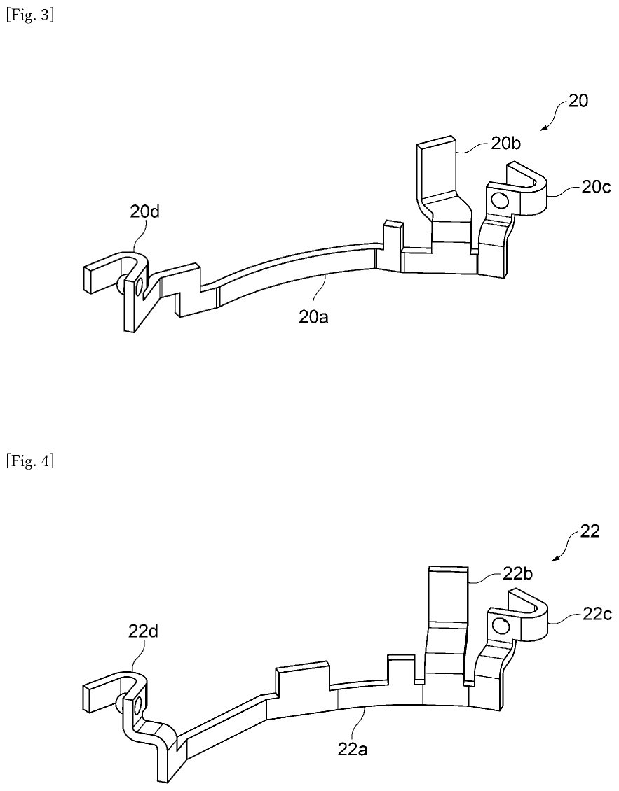

FIG. 3 is a perspective view of the first bus bar 20 according to the present embodiment. The first bus bar 20 has a connection portion 20a, attachment portion 20b, bus bar terminal 20c and bus bar terminal 20d. Moreover, the first bus bar 20 is formed by punching and then bending sheet metal.

The connection portion 20a is formed in a long and narrow substantially rectangular plate shape whose length is not less than ten times as long as the width. When one of the long sides of connection portion 20a is configured as the top end, the connection portion 20a is curved so as to follow along the outer periphery of the annular-shaped resin plate 12, as seen from the top end side thereof. The attachment portion 20b is formed in a long and narrow plate shape whose length is about 1.5 times the width. The bus bar terminal 20c and the bus bar terminal 20d are formed in a U shape by bending a long and narrow rectangular plate at the center.

The bottom portion of attachment portion 20b is integrally joined to the top end of connection portion 20a, so as to extend more further upward than the top end of connection portion 20a. The bus bar terminal 20c and the bus bar terminal 20d are U-shaped as seen from above, and a part of the respective bottom portions thereof are integrally joined to the top end of connection portion 20a, so that the U shapes thereof open at the left side. The bus bar terminal 20c is joined to the top end of the right end of connection portion 20a, and the bus bar terminal 20d is joined to the top end of the left end of connection portion 20a. The attachment portion 20b and bus bar terminal 20c are shifted towards the outside of the curved connection portion 20a system and are joined at connection portion 20a.

FIG. 4 is a perspective view of the second bus bar 22 according to the present embodiment. The second bus bar 22 has a connection portion 22a, attachment portion 22b, bus bar terminal 22c and bus bar terminal 22d. Moreover, the second bus bar 22 is formed by punching and then bending sheet metal.

The connection portion 22a is formed in a long and narrow substantially rectangular plate shape whose length is not less than ten times as long as the width. When one of the long sides of connection portion 22a is configured as the top end, the connection portion 22a is curved so as to follow along the outer periphery of the annular-shaped resin plate 12, as seen from the top end side thereof. The attachment portion 22b is formed in a long and narrow plate shape whose length is about 1.5 times the width. The bus bar terminal 22c and the bus bar terminal 22d are formed in a U shape by bending a long and narrow rectangular plate at the center.

The bottom portion of attachment portion 22b is integrally joined to the top end of connection portion 22a, so as to extend more further upward than the top end of connection portion 22a. The bus bar terminal 22c and the bus bar terminal 22d are U-shaped as seen from above, and a part of the respective bottom portions thereof are integrally joined to the top end of connection portion 22a, so that the U shapes thereof open at the left side. The bus bar terminal 22c is joined to the top end of the right end of connection portion 22a, and the bus bar terminal 22d is joined to the top end of the left end of connection portion 22a. The attachment portion 22b, bus bar terminal 22c and bus bar terminal 22d are shifted towards the outside of the curved connection portion 22a system and are joined at connection portion 22a.

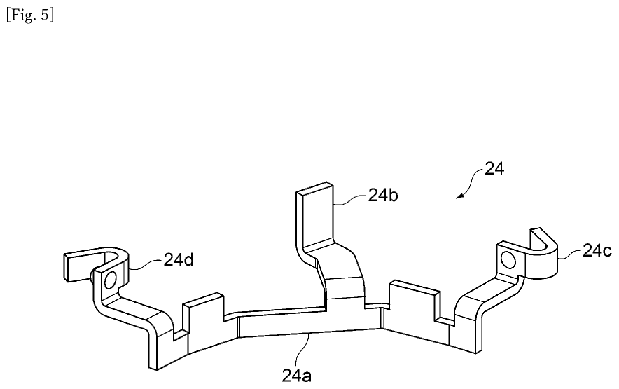

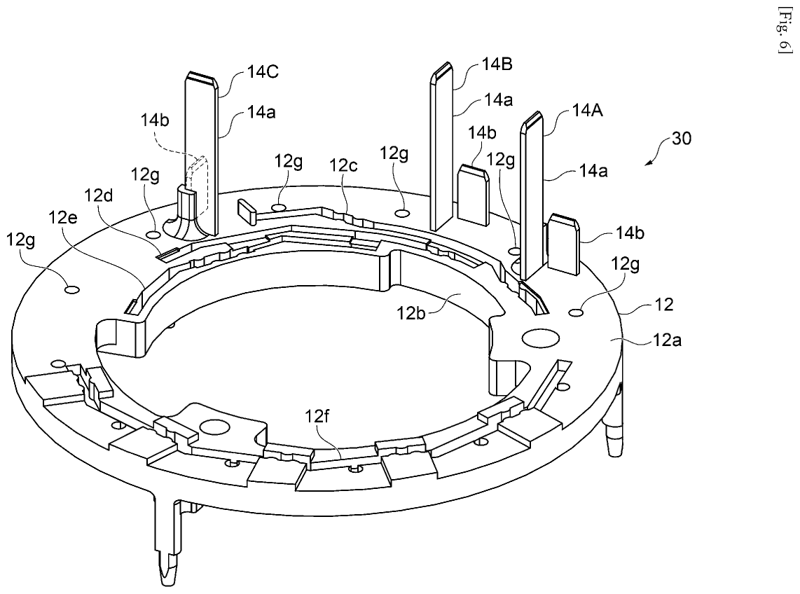

FIG. 5 is a perspective view of the third bus bar 24 according to the present embodiment. The third bus bar 24 has a connection portion 24a, attachment portion 24b, bus bar terminal 24c and bus bar terminal 24d. Moreover, the third bus bar 24 is formed by punching and then bending sheet metal.

The connection portion 24a is formed in a long and narrow substantially rectangular plate shape whose length is not less than ten times as long as the width. When one of the long sides of connection portion 24a is configured as the top end, the connection portion 24a is curved so as to follow along the outer periphery of the annular-shaped resin plate 12, as seen from the top end side thereof. The attachment portion 24b is formed in a long and narrow plate shape whose length is about 1.5 times the width. The bus bar terminal 24c and the bus bar terminal 24d are formed in a U shape by bending a long and narrow rectangular plate at the center.

The bottom portion of attachment portion 24b is integrally joined to the top end of connection portion 24a, so as to extend more further upward than the top end of connection portion 24a. The bus bar terminal 24c and the bus bar terminal 24d are U-shaped as seen from above, and a part of the respective bottom portions thereof are integrally joined to the top end of connection portion 24a, so that the U shapes thereof open at the left side. The bus bar terminal 24c is joined to the top end of the right end of connection portion 24a, and the bus bar terminal 24d is joined to the top end of the left end of connection portion 24a. The attachment portion 24b, bus bar terminal 24c and bus bar terminal 24d are shifted towards the outside of the curved connection portion 24a system and are joined at connection portion 24a.

FIG. 6 is a perspective view of a semi-finished product 30 produced by the process for manufacturing bus bar unit 10. The method for manufacturing a bus bar unit 10 according to the present embodiment includes the steps of: molding first power connection terminal member 14A, second power connection terminal member 14B and power connection terminal member 14C integrally with a resin plate 12 by insert molding; attaching the first bus bar 20, second bus bar 22 and third bus bar 24 to the resin plate 12; and attaching first power connection terminal member 14A, second power connection terminal member 14B and power connection terminal member 14C to first bus bar 20, second bus bar 22 and third bus bar 24 so as to respectively electrically connect to each other. These steps are explained in detail below by means of FIG. 6.

Firstly, the first power connection terminal member 14A, second power connection terminal member 14B and power connection terminal member 14C are molded integrally with resin plate 12 by insert molding. In this way, the semi-finished product 30 illustrated in FIG. 6 is firstly manufactured. When the first power connection terminal member 14A, second power connection terminal member 14B and power connection terminal member 14C were molded integrally with resin plate 12 by insert molding, each power connection terminal 14a and attachment portion 14b respectively protrudes from the resin plate 12 individually.

Next, the connection portion 20a of the first bus bar 20 is press-fitted to a first groove 12c of resin plate 12. The connection portion 22a of second bus bar 22 is moreover press-fitted to a second groove 12d of resin plate 12. The connection portion 24a of third bus bar 24 is moreover press-fitted to a third groove 12e of resin plate 12. Furthermore, the connection portion of fourth bus bar 26 is press-fitted to a fourth groove 12f of resin plate 12. Compared to usual press-fittings, these press-fittings are light press-fittings which press-fit with a small force.

Next, the attachment portion 20b of first bus bar 20 is welded to the attachment portion 14b of the first power connection terminal member 14A. The attachment portion 22b of second bus bar 22 is moreover welded to attachment portion 14b of the second power connection terminal member 14B. Furthermore, the attachment portion 24b of the third bus bar 24 is welded to the attachment portion 14b of the power connection terminal member 14C. Spot welding is employed as the welding in the present embodiment. However, other welding methods such as projection welding and arc welding may also be employed.

Moreover, in the present embodiment, the attachment portion of the power connection terminal member 14 may be attached to the attachment portion of the bus bar by other attaching methods instead of welding. For example, the attachment portion of the power connection terminal member 14 may be attached to the attachment portion of the bus bar by means of a fastener such as screwing or riveting. Moreover, the attachment portion of the power connection terminal member 14 may be attached to the attachment portion of the bus bar by means of brazing.

The method for manufacturing a motor including the bus bar unit 10 further has the steps of: further welding each of the bus bar terminals of first bus bar 20, second bus bar 22, third bus bar 24 and fourth bus bar 26 to the magnet coils of a stator; and connecting the power connection terminal 14a of the power connection terminal member 14 to a connection terminal of a motor circuit board side by mounting the motor circuit board above the bus bar unit 10.

In this way, power connection terminal member 14 is firstly separated from the bus bar, and only the power connection terminal member 14 is insert-molded with the resin plate 12 in the bus bar unit 10 according to the present embodiment. Thereby, compared to the case of press-fitting the power connection terminal member 14 in resin plate 12, or the case of integrating the power connection terminal member to the bus bar and press-fitting the bus bar to the resin plate 12, rattling between a power connection terminal member or bus bar and a groove of resin plate 12 is eliminated, and thus the positional accuracy of the power connection terminal 14a of the power connection terminal member 14 can be improved.

Furthermore, a plurality of peep holes 12g are formed at the resin plate 12. The peep holes 12g are utilized in the step of welding the bus bar terminals to magnet coils of a stator. For example, if the power connection terminal member is formed integrally with the bus bar and the power connection terminal member is insert-molded together with the bus bar to the resin plate 12, formation of the peep holes 12g is difficult due to the existence of the bus bar terminals of the bus bar. If peep holes 12g cannot be formed, positioning and temporary holding of a magnet wire would not be able to take place due at the resin plate 12, and thus welding workability between the magnet wire and the bus bar terminals is reduced. Furthermore, the entire bus bar, which has a large volume, is insert-molded, and thus thermal impact occurs due to the difference of linear expansion coefficient between the resin plate 12 and the bus bar made of metal. Accordingly, it would become necessary to also consider the prevention of occurrence of cracks etc. due to the difference of this linear expansion coefficient.

Based on this, in the present embodiment, the power connection terminal member 14 is separated from the bus bar, and only the power connection terminal member 14 is insert-molded with the resin plate 12 in this way. Therefore, because the bus bar firstly is not insert-molded, peep holes 12g can be appropriately formed, and welding workability between a magnet wire and bus bar terminals can be ensured. Moreover, the need to consider the prevention of the occurrence of cracks due to a difference of the linear expansion coefficient can be reduced.

Furthermore, in the present embodiment, when the power connection terminal member 14 is insert-molded with the resin plate 12, the power connection terminal 14a and attachment portion 14b protrude from surface 12a of resin plate 12 individually. Thereby, when welding the attachment portion 14b of the power connection terminal member 14 to the attachment portion of the bus bar, deformation and inclination of the power connection terminal 14a can be suppressed. Therefore, compared to the case of directly welding the power connection terminal 14a of the power connection terminal member 14 to the attachment portion of the bus bar, reduction of positional accuracy of power connection terminal 14a can be suppressed. Accordingly, an appropriate fit between a connector of the motor circuit board side and the power connection terminal 14a can be achieved.

The present invention is explained as above by referring to the embodiment; however, the present invention is not limited to the aforementioned embodiment, where suitably combined or substituted configurations of the embodiment are also included in the present invention. Moreover, combinations or orders of processes may be suitably rearranged in the embodiment, or modifications such as design changes may be added to the embodiment, based on the knowledge of the person skilled in the art, where embodiments to which such modifications were added may also be included in the scope of the present invention.

12 Resin plate, 12a Surface, 12b Opening, 12c First groove, 12d Second groove, 12e Third groove, 12g Peep holes, 14 Power connection terminal member, 14a Power connection terminal, 14b Attachment portion, 14c Connection portion, 14A First power connection terminal member, 14B Second power connection terminal member, 14C Power connection terminal member, 20 First bus bar, 20a Connection portion, 20b Attachment portion, 20c Bus bar terminal, 20d Bus bar terminal, 22 Second bus bar, 22a Connection portion, 22b Attachment portion, 22c Bus bar terminal, 22d Bus bar terminal, 24 Third bus bar, 24a Connection portion, 24b Attachment portion, 24c Bus bar terminal, 24d Bus bar terminal, 30 Semi-finished product

1. A method for manufacturing a bus bar unit for a motor, comprising the following steps of:
molding a connection terminal member integrally with a resin plate by insert molding, said connection terminal member having a connection terminal for connecting to an external device and an attachment portion for attaching to a bus bar electrically connected to coils of a stator, wherein said connection terminal and said attachment portion each protrude from said resin plate individually;
attaching said bus bar to said resin plate; and
attaching said bus bar to said attachment portion of said connection terminal member so as to electrically connect each other.

2. The method according to claim 1, further comprising welding said bus bar to said attachment portion of said connection terminal member, in the step of attaching said bus bar to said attachment portion of said connection terminal member.

3. The method according to claim 1, further comprising press-fitting said bus bar to said resin plate, in the step of attaching said bus bar to said resin plate.

4. A bus bar unit for a motor, comprising:
a resin plate;
a connection terminal member molded integrally with said resin plate, for connecting to an external device; and
a bus bar attached to said resin plate, for electrically connecting to coils of a stator;
wherein said connection terminal member has a connection terminal for connecting to an external device, and an attachment portion for attaching to said bus bar, wherein said connection terminal and said attachment portion each protrude from said resin plate individually; and
wherein said bus bar is for attaching to said attachment portion of said connection terminal member so as to electrically connect each other.

5. A motor, comprising a bus bar unit, the bus bar unit including:
a resin plate;
a connection terminal member molded integrally with said resin plate, for connecting to an external device; and
a bus bar attached to said resin plate, for electrically connecting to coils of a stator;
wherein said connection terminal member has a connection terminal for connecting to an external device, and an attachment portion for attaching to said bus bar, wherein said connection terminal and said attachment portion each protrude from said resin plate individually; and
wherein said bus bar is for attaching to said attachment portion of said connection terminal member so as to electrically connect each other.

6. The motor according to claim 5, wherein the bus bar is welded to the attachment portion of the connection terminal member.

7. The motor according to claim 5, wherein the bus bar is press-fitted to the resin plate.

8. The bus bar unit of claim 4, wherein the bus bar is welded to the attachment portion of the connection terminal member.

9. The bus bar unit of claim 4, wherein the bus bar is press-fitted to the resin plate.

10. The method according to claim 1, further comprising welding the bus bar to the attachment portion of the connection terminal member.

11. The method according to claim 1, further comprising press-fitting the bus bar to the resin plate.

12. The method according to claim 2, wherein attaching the bus bar to the resin plate includes press-fitting the bus bar to the resin plate.
